(19) United States
(12) Patent Application Publication
(10) Pub. No.: US 2005/0209975 A1
(43) Pub. Date: Sep. 22, 2005

(54) System, method and computer program product for conducting a secure transaction via a network

(75) Inventors: Wilson Sing-Hei So, Cupertino, CA (US); Yoichi Shintani, Palo Alto, CA (US); Tomohisa Kohiyama, Sunnyvale, CA (US)

Correspondence Address: SQUIRE, SANDERS & DEMPSEY L.L.P, 600 HANSEN WAY, PALO ALTO, CA, 94304-1043, US

(73) Assignee: Hitachi, Ltd., Tokyo (JP)

(21) Appl. No.: 10/805,017

(22) Filed: Mar. 18, 2004

(51) Int. Cl. G06F 17/60

(52) U.S. Cl. 705/71

(57) ABSTRACT

A system, method and computer program product for conducting a secure transaction via a network is disclosed. Coupled to a network are a first site and a terminal for permitting a user to perform a first portion of a transaction at the first site via the network. A second site is also coupled to the network for performing a second portion of the transaction which requires the use of personal data of the user. The second site is contacted by the first site via the network to perform the second portion of the transaction. In response, the second site transmits a certificate for verifying the identity of the second site to the terminal via the network. After the terminal authenticates the certificate, the second site then transmits a request for the personal data to the terminal via the network. A secure device associated with the user is coupled to the terminal. The secure device contains an encrypted version of the personal data and a first key for decrypting the encrypted personal data. In response to the request for personal data, the secure device provides the terminal with the encrypted personal data and the first key. The terminal decrypts the encrypted personal data using the first key, re-encrypts the decrypted personal data with a second key, and then transmits the re-encrypted personal data to the second site via the network.

### BACKGROUND

This invention relates generally to performing transactions via a network and more particularly to systems and processes for performing secure transactions via a network such as the Internet.

In today's eBusiness world, personal data about a customer or “user” may often be stored at the eBusiness web site with the user having little or no control over the information. For example, when a user goes to an online bookstore to make a purchase as a first time buyer, the user may need to create an account with the online bookstore. In creating the account, the online bookstore may obtain and store personal data about the user such as the user's name, mailing address, credit card information and billing address, etc. Access to the created account and store information may be protected by username and password. Now, suppose the user returns to the online bookstore a second time as a repeat buyer but this time the user decides to use a different identity than the one used during the last transaction. For example, let's assume the user created the account with the online bookstore the first time as an employee of Company ABC. However, on the second visit, the user may want to purchase something from the online bookstore for personal use. As a result of the change in identity, the user may need to update his or her account information by adding the appropriate personal data (e.g., different credit card, email address, and billing information).

Storing personal data on an eBusiness web site creates some security risks. Since eBusiness web sites frequently contains huge amounts of personal data, it makes for an attractive target for malicious attack to steal that information. If the eBusiness web site is broken into (i.e., hacked), then the personal data associated with all the users using that eBusiness service may be exposed to the intruder (i.e., the hacker).

Storing personal data in a terminal device coupled to the network that is used by the user to access the network (e.g., a personal computer coupled to the Internet) also presents security risks. This approach may require that the user store copies of the same personal data in several terminal devices thereby compounding the problem of security of the personal data. Further, storing the same personal information on several terminal devices may lead to problems with version control because it requires that any updates to the personal data be performed at each terminal in which the personal data is stored.

### SUMMARY

A system, method and computer program product for conducting a secure transaction via a network is disclosed. Coupled to a network are a first site and a terminal for permitting a user to perform a first portion of a transaction at the first site via the network. In one embodiment, the transaction may comprise a commercial transaction and the first site may comprise an e-commerce site.

A second site is also coupled to the network for performing a second portion of the transaction which requires the use of personal data of the user. The second site is contacted by the first site via the network to perform the second portion of the transaction. In response, the second site transmits a certificate for verifying the identity of the second site to the terminal via the network. After the terminal authenticates the certificate, the second site then transmits a request for the personal data to the terminal via the network. In one embodiment, the personal data may include credit card information and/or credit history information.

A secure device associated with the user is coupled to the terminal. In one embodiment, the secure device may be detachably coupled to the terminal. The secure device contains an encrypted version of the personal data and a first key for decrypting the encrypted personal data. In one embodiment, the secure device may include a special region that, if tampered with, renders the secure device inoperable and thereby prevent access to the first key contained therein.

In response to the request for personal data, the secure device provides the terminal with the encrypted personal data and the first key. In one embodiment, the secure device may provide the terminal with the encrypted personal data prior to and separately from the first key. In another embodiment, a second certificate associated with the terminal may be provided to the secure device to authenticate the terminal before the secure device provides the terminal with the encrypted personal data and first key.

The terminal decrypts the encrypted personal data using the first key, re-encrypts the decrypted personal data with a second key, and then transmits the re-encrypted personal data to the second site via the network. In one embodiment, the second key may comprise a public key associated with the second site. The second site decrypts the re-encrypted personal data with the second key and then uses the personal data to complete the second portion of the transaction.

In one embodiment, communications between the terminal and the secure device and between the terminal and the second site may be encrypted with one or more symmetric keys. In another embodiment, a list containing information for authenticating the certificate of the second site may be transmitted from the first site to the terminal via the network prior to receipt of the certificate by the terminal. In a further embodiment, a notification may be transmitted from the second site to the first site via the network upon completion of the second portion of the transaction.

### BRIEF DESCRIPTION OF THE DRAWINGS

FIG. 1 is a schematic block diagram of a system for conducting a secure transaction that may be utilized to facilitate online identity management in a web services connected eBusiness world in accordance with an embodiment of the present invention;

FIG. 2 is a schematic flowchart of a process for conducting a secure transaction in the system set forth in FIG. 1 in accordance with an embodiment of the present invention;

FIG. 3 is a schematic flowchart of a remainder of the process for conducting a secure transaction in the system set forth in FIG. 2 in accordance with an embodiment of the present invention;

FIG. 4 is a schematic flowchart of certificate and key traffic between the terminal, second site and secure device in accordance with an exemplary embodiment of the present invention;

FIG. 5 is a legend of the notations used in FIG. 4 in accordance with an exemplary embodiment of the present invention;

FIG. 6 is a schematic block diagram of an illustrative secure device in accordance with an exemplary embodiment of the present invention;

FIG. 7 is a flowchart of a process for conducting a secure transaction via a network from the terminal's perspective in accordance with an embodiment of the present invention;

FIG. 8 is a flowchart of a process for conducting a secure transaction via a network from the second site's perspective in accordance with an embodiment of the present invention;

FIG. 9 is a schematic diagram of an illustrative network system with a plurality of components in accordance with an embodiment of the present invention; and

FIG. 10 is a schematic diagram of a representative hardware environment in accordance with an embodiment of the present invention.

### DETAILED DESCRIPTION

Embodiments of the present invention help to provide solutions to problems relating to online identity management by helping to place the control of personal data back in the hands of the users. In this way, an eBusiness web site may be relieved of the burden of storing and managing personal data of its users thereby helping to increase the protection of the personal data (such as credit card information) as well as the level of data privacy (such as personal credit history). Embodiments of the present invention may help to solve problems with online identity management by storing an encrypted version of the user's personal data with the associated encryption key used to encrypt the personal data in a secure device. The secure device may be portable across a multitude of terminal devices. Since the encryption key and the encrypted personal data are stored in the same secure device, key management issues are reduced. The secure device may also include a special protected region to store the encryption key. The special protected region affords additional protection to the storage of encryption keys by rendering the secure device useless if the special protected region is tampered.

Storing personal data on eBusiness web sites is a legacy issue that remains from the earlier days of eCommerce. However, with the emergence of Web Services as a new distributing computing paradigm to facilitate machine-to-machine interaction, it may also be important to return personal data to the hands of the users. In the future, enterprises may become more dynamic and adaptable to changes surrounding them and become “organic enterprises.” For example, an enterprise may add and remove its partners in real time due to changes in business conditions. In such a scenario, each time a user enters eBusiness web site, the eBusiness web site may simply communicate to the user the most updated list of partners so that personal data will always be submitted to the correct party to complete an eBusiness transaction.

Embodiments of the present invention help an eBusiness user to control his or her own personal data with the use of a secure device in a Web Services connected eBusiness world. The secure device may be used to store an encrypted version of the user's personal data as well as the corresponding encryption keys. The encryption keys may even be stored in a special protected region inside the secure device. The secure device may also be capable of storing a number of keys that may be used for personal data encryption. These keys, which may be in the form of symmetric keys, may be stored in a special protected region inside the secure device that is designed to render the secure device useless when tampered. Access to a subset of the personal data (e.g., credit card information, personal credit history, etc.) may be granted on a site-by-site basis and based on the need of a transaction. In an illustrative embodiment for example, if the user/customer is making a purchase from an eCommerce web site, then only the user's credit card and mailing address information may be provided by the secure device. When it comes time to submit the personal data in order to perform an eCommerce transaction, a partner associated with the eCommerce web site and involved in providing the service on behalf of the eCommerce web site may obtain the personal data directly from the user/customer. In this example, the partner may comprise a credit card clearinghouse coupled to the network and affiliated in some way with the eCommerce site. The credit card clearinghouse may receives only the credit card information while the eCommerce company may receive only the mailing address. As can be seen, there may be no need for the credit card information to be deposited at the eCommerce web site, which may have no reason to handle that piece of the personal data if not for the fact that it has been serving as a conduit to forward that information onward to the credit card clearinghouse.

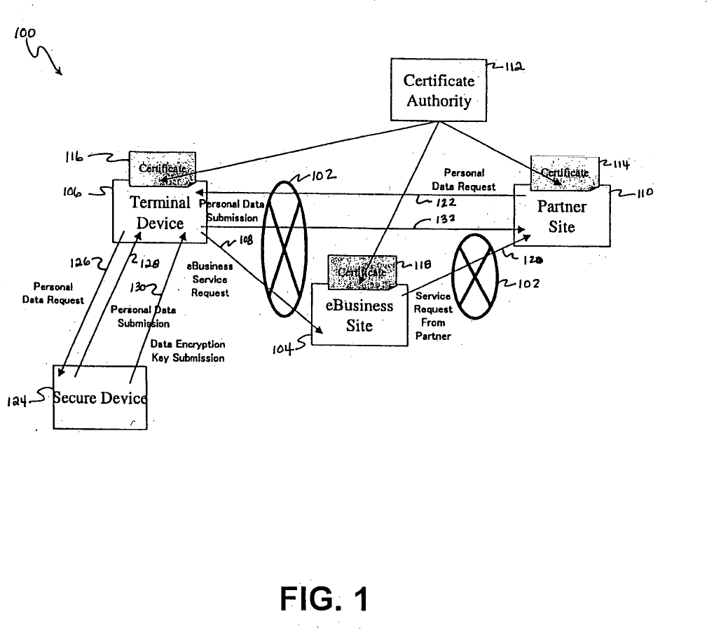

FIG. 1 is a schematic block diagram of a system 100 (or service model) for conducting a secure transaction that may be utilized to facilitate online identity management in a web services connected eBusiness world in accordance with an embodiment of the present invention. System 100 includes a network 102 which, for example, may comprise a wide area network such as the Internet. Coupled to the network 102 is a first site 104 where a transaction or a portion thereof may be performed. In one embodiment, the first site may comprise an e-commerce site and the transaction performed at the first site may comprise a commercial transaction.

Also coupled to the network 102 is a terminal 106 through which a user (or subject/party/authorized agent of the user) may initiate the performance of a first portion of the transaction with the first site 104 via the network 102 (see arrow 108). It should be understood that the first portion of the transaction may be any portion of the transaction, including an initial portion of the transaction or a portion occurring during the middle of the transaction (i.e., a “middle portion”). Personal data about the user may not be needed or used in this first portion of the transaction. In the exemplary embodiment illustrated in FIG. 1, the terminal 106 may initiate the performance of an eBusiness service transaction by a eBusiness service request 108 transmitted via the network 102. In an illustrative eBusiness exemplary embodiment, the user may be a customer to a online bookstore. The user may browse book selections provided by the online bookstore without having to provide identifying information about the user to the online bookstore.

A second site 110 is also coupled to the network 102 for performing a second portion of the transaction. The second portion of the transaction may comprise a middle portion or a remainder portion of the transaction. Performance of the second portion of the transaction requires the use of personal data of the user. In one embodiment, the personal data may include credit card information (e.g., credit card account number, expiration date, and security codes such as the type found on the signature block on the back of a credit card) and/or credit history information about the user. Other illustrative examples of personal data may include a password, a preferred method of payment, identification of a preferred credit card, a billing address associated with the credit card.

In an exemplary embodiment, the second site 110 may a partner site of the first site 104. That is, the second site 110 may have a special relationship with the first site 104. For example, the second site 110 may be a preferred provider of a service for transactions initiated at the first site. In an illustrative embodiment, the second site 110 may comprise a credit card clearinghouse with the ability to perform the payment executing portion(s) of the transaction (which may be needed to complete a commercial transaction).

In the online bookstore exemplary transaction previously discussed, the second portion of the transaction may be initiated once the user has completed selection of books that he or she wishes to purchase from the online bookstore and has proceeded to the checkout portion of the their transaction. At the time of checkout, the online bookstore may need to process the payment, figure out where to ship the selected books, etc. The user's name and mailing information and other non-personal (i.e., non-private or public) information/data may be obtained by the online bookstore as part of the first portion of the transaction. In general, non-personal data about the user may comprise information about or associated with the user that the user does not necessarily mind being made publicly available or at risk. Examples of non-personal or public data may include a username associated with the user for the online bookstore, and an email address of the user.

The collection of the user's credit card information (e.g., credit card account number, credit card expiration date, and security code located on the signature block on the back of the credit card) is performed in the second portion of the transaction conducted by the credit card clearinghouse that may be authorized or affiliated with the online bookstore (i.e., the credit card clearinghouse comprises the second or “partner” site in this exemplary embodiment). It should be noted that the second portion of the transaction may not necessarily have to occur subsequently after the completion of the first portion of the transaction. In one optional embodiment, the second portion of the transaction may be initiated and/or performed before the initiation and/or performance of the first portion of the transaction. For example, in our online bookstore illustration, the collection of the credit card information (i.e., part of the second portion of the transaction) may be obtained by the credit card clearinghouse before the online bookstore has completed collecting all of the information in needs from the user to complete the first portion of the transaction. For example, the online bookstore may present the user with options for receiving (or refusing) online or email advertisements after the credit card information is requested by the credit card clearinghouse.

A certificate authority 112 may also be coupled to the network 102. The certificate authority 112 may issue digital certificates 114, 116, 118 (“certificates”) to one or more of the second site 110, the terminal 106, and the first site 104 for authentication purposes. In one embodiment, the certificates may comprise X.509 digital certificates.

The second site 110 may be contacted by the first site 104 via the network to perform the second portion of the transaction. This contact may be achieved, for example, by the transmission of a request 120 from the first site to the second site that requests the performance of the second portion of the transaction. In the exemplary embodiment illustrated in FIG. 1, the first site 104 may contact the second site 110 to perform the second portion of the eBusiness transaction through transmission of a “service request from partner” 120 (i.e., the request) transmitted via the network 102. In an optional embodiment, rather than the first site 104 transmitting the request for performance of the second portion of the transaction, the terminal 106 may contact the second site 110 via the network 102 and provide the request instead of the first site to request performance of the second portion of the transaction.

In response to the request 120, the second site 110 transmits its certificate 114 for verifying the identity of the second site 110 to the terminal 106 via the network 102. The terminal 106 authenticates the certificate 114 to verify the identity of the second site 110 and then transmits via the network 102 an indication to the second site 110 that indicates that the certificate 114 has been authenticated and that the second site 110 may request personal data from the terminal 106. After the second site 110 receives the indication that the terminal 106 has authenticated the certificate 114, the second site 110 then transmits a request 122 for the personal data to the terminal 106 via the network 102.

A secure device 124 associated with the user is coupled to the terminal 106. In one embodiment, the secure device 124 may be detachably coupled to the terminal and may also be easily portable by a user. The secure device 124 contains an encrypted version of the personal data and a first key for decrypting the encrypted personal data. In one embodiment, the secure device 124 may include a special region that, if tampered with, renders the secure device 124 inoperable and useless to thereby prevent access to the first key contained therein. As an option, the first key may be stored in a portion of the memory of the secure device that is located in the special region so that if that secure device is tampered with, access to the first key is prevented. In one embodiment, there may be a one-to-one relationship between the encrypted personal data and the corresponding encryption key to help reduce problems with key management. In yet another embodiment, the encryption key(s) used to encrypt the personal data stored in the secure device may comprise a symmetric key.

In response to the request 122 for personal data from the second site 110, the terminal 106 in turn requests 126 the personal data from the secure device 124. The secure device 124 provides the terminal 106 with the encrypted personal data 128 and the first key 130. In one embodiment, the secure device 124 may provide the terminal 106 with the encrypted personal data 128 prior to and separately from the first key 130. Conversely, in an alternative embodiment, the secure device 124 may first provide the terminal 106 with the first key 130 and then afterwards, provide the encrypted personal data 128 separately. In even another embodiment, a second certificate 116 associated with the terminal 106 may be provided to the secure device 124. In such an embodiment, the secure device 124 may contain logic capable of authenticating the second certificate 116 (and thus the terminal 106) before the secure device 124 provides the terminal 106 with the encrypted personal data 128 and first key 130. In yet another embodiment, the secure device 124 may have a password associated therewith (or some other user authenticator) that must be input by a user via the terminal 106 to ensure that the user is an authorized user before the encrypted personal data and associated key is provided to the terminal 106. In one such embodiment, the secure device 124 may require that a personal identification number (PIN) be input by the user into the terminal 106 and transmitted from the terminal 106 to the secure device 124. The secure device 124 may then compare the input PIN with PIN information associated with the user that is stored in the secure device 124 to determine whether the user is an authorized user of the secure device 124. If the input PIN matches the PIN information stored in the secure device 124, the requested encrypted personal data and the associated key stored in the secure device 124 may then be transmitted to the terminal 124 as set forth above.

The terminal 106 decrypts the encrypted personal data 128 using the first key 130, re-encrypts the decrypted personal data with a second key, and then transmits the re-encrypted personal data 132 to the second site 110 via the network 102. In one embodiment, the second key may comprise a public key associated with the second site 110.

The second site 110 decrypts the re-encrypted personal data 132 with the second key and then uses the personal data to complete the second portion of the transaction.

In one embodiment, communications (or at least a portion thereof) between the terminal 106 and the secure device 124 and between the terminal 106 and the second site 110 may be encrypted with one or more symmetric keys. In another embodiment, a list containing information for authenticating the certificate of the second site may be transmitted from the first site 104 to the terminal 106 via the network 102 prior to receipt of the certificate 114 by the terminal 106 from the second site 110. As an option, the list may also include information identifying certificates that have been revoked and/or that are no longer valid.

In a further embodiment, a notification may be transmitted from the second site 110 to the first site 104 via the network 102 upon completion of the second portion of the transaction. This notification may be used to indicate to the first site 104 the completion of the second portion of the transaction by the second site 110.

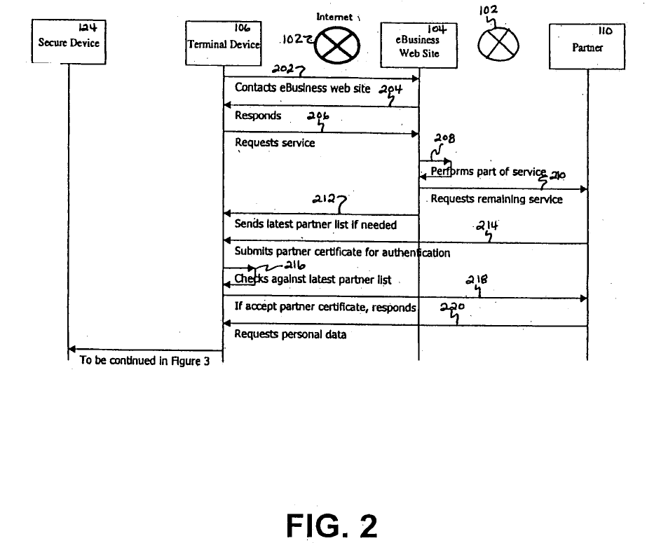

FIG. 2 is a schematic flow chart of a process for conducting a secure transaction in the system 100 set forth in FIG. 1 in accordance with an embodiment of the present invention. The processes starts with the terminal 106 initiating a contact with the first site 104 via the network 102 and the first site 104 responding in turn (see operations 202 and 204) to establish a contact between the terminal 106 and the first site 104. Once the contact has been established, the terminal 106 transmits a request for performance of a transaction to the first site 104 via the network 102 in operation 206.

In response to the request by the terminal 106 in operation 206, the first site 104 performs a first portion of the requested transaction in operation 208. In operation 210, the first site 104 contacts the second site 110 via the network to request that the second site 110 perform a second portion of the transaction. In operation 210, the kind of data that is sent to the second site 110 includes the source information of the terminal device 106. For example, if the terminal device 106 is located behind a corporate firewall, the source information of the terminal device 106 will contain the public IP address of the firewall and an alias port number, which allows translation to the source IP address and port number of the terminal device 106. In another embodiment, it the terminal device 106 is a cellular phone enabled with a mobile IP address (i.e. routable), then the source information will contain the mobile IP address.

After contacting the second site 110, the first site 104 may also provide the terminal 106 with an up-to-date list of certificates which was encrypted with first site's private key in operation 212. In response to the request from the first site 104 (see in operation 210), the second site 110 transmits its certificate 114 to the terminal 106 via the network 102 in operation 214.

In operation 216, the terminal 106 compares the certificate it received from the second site 110 in operation 214 with the list it received from the first site 104 in operation 212 to authenticate the certificate and thereby verify the identity of the second site 110. If the second site's certificate is authenticated, then the terminal transmits a response to the second site 110 via the network 102 (see operation 218) that indicates the authentication the certificate by the terminal 106.

After receiving the response from the terminal 106 (see operation 218), the second site 110 transmits a request to the terminal 106 via the network 102 in operation 220 that requests the personal data needed to perform the second portion of the transaction.

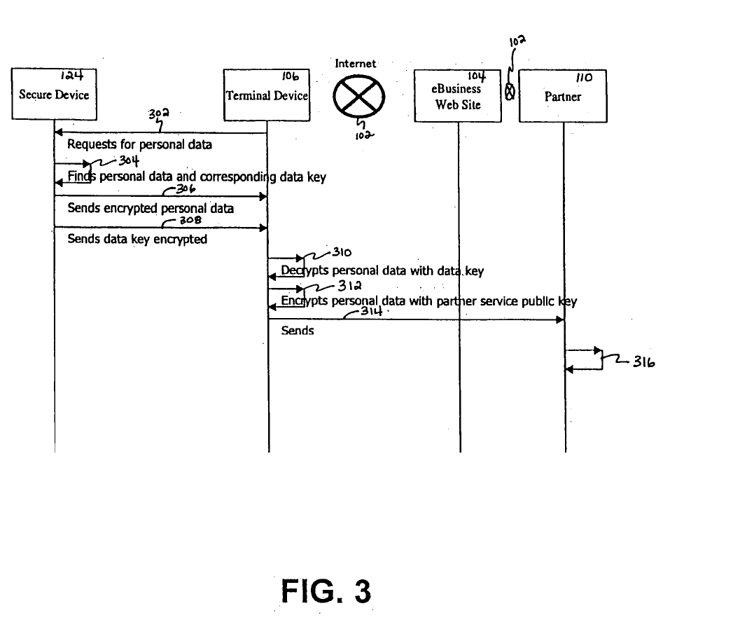

FIG. 3 is a schematic flowchart of a remainder of the process for conducting a secure transaction in the system 100 set forth in FIG. 2 in accordance with an embodiment of the present invention. After transmission of the request for personal data in operation 220 (see FIG. 2), the terminal 106 transmits a request to the secure device 124 for the personal data requested by the second site 110 in operation 302.

In operation 304, the secure device 124 retrieves an encrypted version of the requested personal data and an associated key for decrypting the encrypted personal data. In operation 306, the secure device 124 forwards the retrieved encrypted personal data to the terminal 106 and then forwards the retrieved key to the terminal 106 in operation 308.

In operation 310, the terminal 106 decrypts the encrypted personal data using the key received in operation 308 and then re-encrypts the decrypted personal data with a second key in operation 312. In the exemplary embodiment as shown in FIG. 3, the second key may comprise a public key associated with the second site 110. In operation 314, the terminal 106 transmits the re-encrypted personal data to the second site 110 via the network 102. The decrypted personal data by the terminal 106 is erased. In another embodiment, the secure device 124 may decrypt the encrypted personal data using the retrieved key, and may forward the decrypted personal data to the terminal 106. The terminal 106 then encrypts the decrypted personal data with a second key in operation 312. In this embodiment, since the retrieved key remains in the secure device 124, it is safe.

Upon receipt of the re-encrypted personal data, the second site 110 decrypts the re-encrypted personal data with the second key in operation 316 and then uses the personal data to complete the second portion of the transaction.

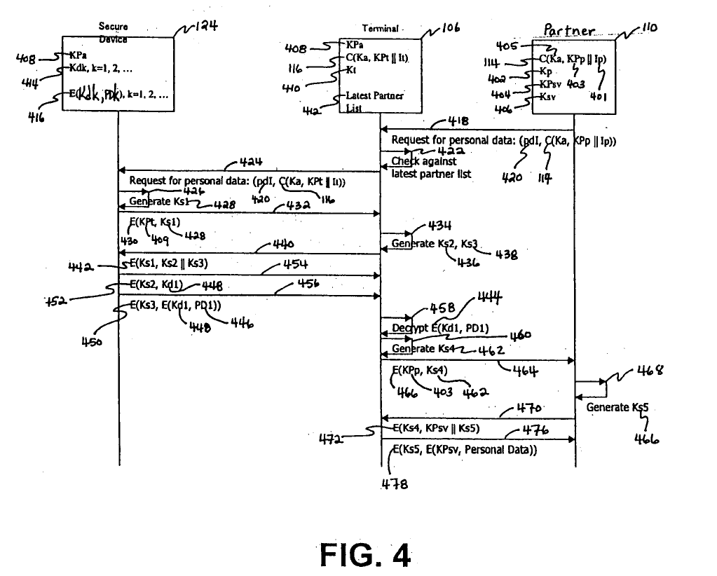

FIG. 4 is a schematic flowchart of certificate and key traffic between the terminal 106, second site 110 and secure device 124 in an exemplary implementation of a portion of the process for conducting a secure transaction taking place after the first site 104 has contacted the second site 110 to request that the second site 110 perform a second portion of the secure transaction in accordance with an embodiment of the present invention. It should also be understood that portions of the process illustrated in FIGS. 2 and 3 may be performed in accordance with the operations set forth in FIG. 4. FIG. 4 gives the details about the traffic of certificates and keys between all of the parties described therein (i.e., secure device, terminal (the “terminal device”), and the second site (the “partner”)). For the purpose of discussing the process set forth in FIG. 4, it is assumed that the terminal 106 has already received the latest list of certificates from the first site 104 (the “eBusiness web site”) one way or another.

As illustrated in FIG. 4, the second site 110 has its associated certificate 114 (e.g., “C(Ka, KPp||Ip)”), an associated private key 402 (e.g., “Kp”), an associated service public key 404 (e.g., “KPsv”), and an associated service private key 406 (e.g., “Ksv”). In the exemplary embodiment shown in FIG. 4, the certificate 114 may include information 401 (e.g., “Ip”) about the second site 110, a public key 403 (e.g, “KPp”) associated with the second site 110, and a digital signature generated using a private key 405 (e.g., “Ka”) of the certificate authority 112.

The terminal 106 has a certificate authority's public key 408 (e.g., “.KPa”), its associated certificate 116 (e.g., “C(Ka, Kpt||It)”), an associated private key 410 (e.g., “Kt”), and an up-to-date list of certificates 412 (e.g., “Latest Partner List”). In the exemplary embodiment shown in FIG. 4, the certificate 116 may include information 407 (e.g., “It”) about the terminal 106, a public key 409 (e.g. “KPt”) associated with the terminal 106, and a digital signature generated using the private key 405 of the certificate authority 112.

Secure device 124 has a version of the certificate authority's public key 408 (e.g., “KPa”), one or more personal data encryption keys 414 (e.g., “Kdk, k=1, 2, . . . ”), and encrypted version(s) of the personal data 416 (e.g., “E(PDk, Kdk), k=1, 2, . . . ”) encrypted using the one or more personal data encryption keys 414.

In operation 418 of the exemplary embodiment shown in FIG. 4, the second site may transmit (over the network 102) the request for the needed personal data (e.g., “pdl” 420) along with its certificate 114 at the same time rather than separately as set forth in FIG. 2 (see operations 214 and 220). In operation 422 (which is similar to operation 216 of FIG. 2), the terminal A106 compares the certificate 114 provided by the second site 110 against the information contained in the list of certificates 412 to authenticate the certificate 114 and thereby verify the identity of the second site 110. If the second site's certificate 114 is authenticated by the terminal 106, then the terminal 106, in operation 424, transmits a request to the secure device 124 for the needed personal data 420 that was requested by the second site 110 (see operation 422) along with a copy of the terminal's certificate 116.

In operation 426, the secure device 124 generates a first session key 428 (e.g., “Ks1”). The secure device 124 encrypts the first session key 428 with the terminal's public key 409 (obtained from the terminal's certificate 116) and then transmits the encrypted first session key 430 to the terminal 106 in operation 432. In operation 434, the terminal 106 may generate second and third session keys 436, 438. The terminal 106 may decrypt the encrypted first session key 430 it received from the secure device 124 and use the decrypted first session key 428 to encrypt the second and third session keys 436, 438. In operation 440, the terminal 106 transmits the encrypted second and third session keys 436, 438 to the secure device 124. The secure device 124 may decrypt the encrypted second and third session keys 436, 438 using the first session key 428.

In response to the request for personal data from the terminal 106 (see operation 424), the secure device 124 retrieves from its memory an encrypted version (e.g., “E(Kd1, PD1)” 444) of the requested personal data (e.g., “PD1” 446) and the associated personal data encryption key (e.g., “Kd1” 448) used to generate the encrypted personal data 444. The secure device 124 separately encrypts both the encrypted personal data 444 and its associated personal data encryption key 446 using the second and third encryption keys 436, 438 to generate a “twice” encrypted version 450 (e.g., “E(Ks3, E(Kd1, PD1))”) of the encrypted personal data 444, and an encrypted version 452 (e.g., “E(Ks2, Kd1)”) of its associated personal data encryption key 448. In the exemplary embodiment shown in FIG. 4, the twice encrypted personal data 450 is generated using the third session key 438 and the encrypted personal data encryption key 452 is generated using the second session key 436. However, it should be understood that embodiments may be implemented where the twice encrypted personal data 450 may be generated using the second session key 436 and the encrypted associated personal data encryption key 452 may be generated using the third session key 4038.

In operations 554 and 556, the encrypted associated personal data encryption key 452 and the twice encrypted personal data 450 are transmitted, preferably separately (as shown), to the terminal 106. It should be understood that the order in which the encrypted associated personal data encryption key 452 and the twice encrypted personal data 450 are transmitted to the terminal 106 may be reversed, however, in a preferred embodiment, the element transmitted first to the terminal should be encrypted using the second session key 436 and the element transmitted last should be encrypted using the third session key 438 to aid in the decryption of these elements 450, 452 by the terminal 106. Further, it should also be understood that embodiments may be implemented where the associated personal data encryption key 448 may be encrypted and transmitted to the terminal 106 even before the encrypted personal data 444 is “twice” encrypted using the third session key 438.

The encrypted associated personal data encryption key 452 and the twice encrypted personal data 450 may be decrypted by the terminal 106 using the second and third session keys 436, 438 respectfully. In operation 458, the terminal then uses the decrypted personal data encryption key 448 to decrypt the encrypted personal data 444 to obtain the personal data 446 provided by the secure device 124. The terminal 106 generates a fourth session key 462 (e.g., “Ks4”) in operation 460, and then encrypts the fourth session key with the second site's public key 403 obtained from the second site's certificate 114 (see operation 418). In operation 464, the terminal 106 transmits the encrypted version of the fourth session key 466 (e.g., “E(KPp, Ks4)”) to the second site 110 via the network 102.

The second site 110 decrypts the fourth session key 462 and uses the fourth session key 462 to encrypt the second site's service public key 404 and a fifth session key 466 which is generated by the second site 110 in operation 468. In operation 470, the second site 110 transmits the encrypted version 472 (e.g., “E(Ks4, KPsv Ks5)”) of its service public key 404 and fifth session key 466 to the terminal 106. Upon receipt, the terminal 106 decrypts this encrypted transmission 472 to obtain the second site's service public key 404 and the fifth session key 466. Next, the terminal uses the second site's service public key 404 to encrypt the personal data 444 obtained from the secure device 124 and encrypts the encrypted version of the personal data 474 (e.g., “E(KPsv, Personal Data)”) again using the fifth session key 468. In operation 478, the terminal 106 transmits the resulting encryption 476 (e.g., “E(Ks5, E(KPsv, Personal Data))”) to the second site 110 via the network 102. The second site 110 may decrypt the encrypted transmission 478 using the fifth service key 466. and its service private key 406 to obtain a decrypted version of the personal data 446 provided by the secure device. The second site may then use the personal data 446 to complete the portion of the transaction requiring the personal data 446 (i.e., the second portion of the transaction).

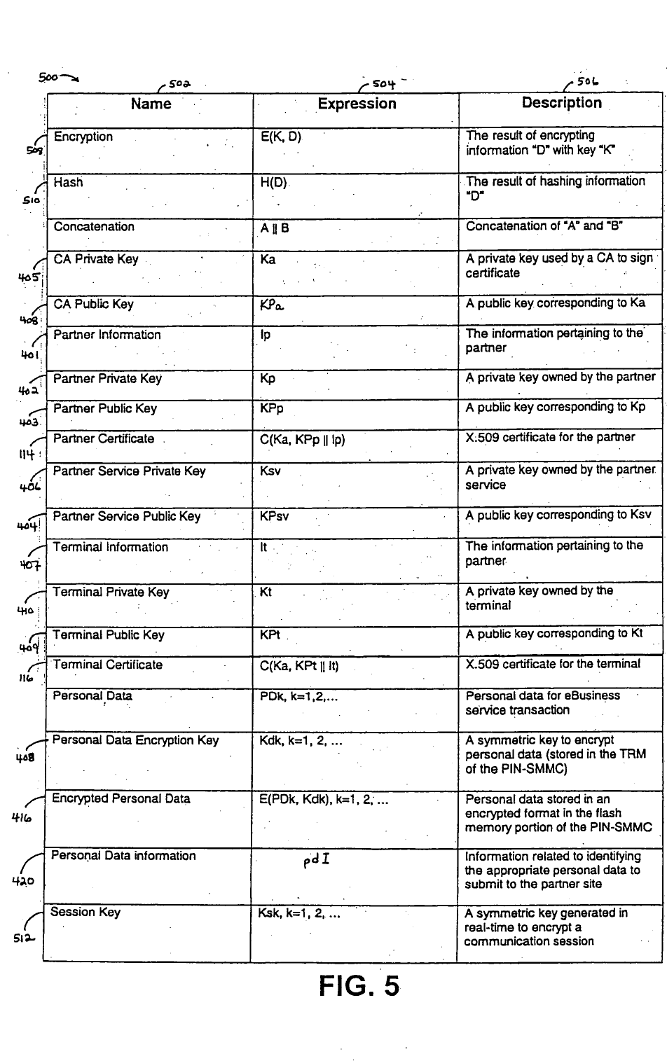

FIG. 5 is a legend 500 of the notations used in FIG. 4 in accordance with an exemplary embodiment of the present invention shown in FIG. 4. Legend 500 includes a name column 502 for the names of terms set forth in the legend 500, an expression column 504 for the expressions or notations associated with the terms, and a description column 506.

In general, under the nomenclature system used in FIG. 4, an encryption 508 is represented using the notation “E(K,D)” with the “E” indicating an encryption of information “D” that is generated using key “K.” In addition, a hash (or “hash value”) 510 is a value obtained by the transformation of a character string using a hash algorithm (or “hash function”) in a process commonly known as hashing. Hashing may be used to encrypt and decrypt digital signatures. The digital signature is transformed with the hash function and then both the hashed value (known as a message-digest) and the signature are sent in separate transmissions to the receiver. Using the same hash function as the sender, the receiver derives a message-digest from the signature and compares it with the message-digest it also received. They should be the same.

Legend 500 also sets forth several notations for private keys (e.g., private keys 402, 405, 406, 410) and public keys (e.g., public keys 403, 404, 408, 409). In embodiments, the private and public keys are used for carrying out asymmetric cryptography under a public key infrastructure (also known as “PKI”). In general, under a public key infrastructure, a party's public key is made available to other parties for encrypting information intended for the party while the party's private key is kept secret by the party and is used by the party to decrypt information encrypted using the public key.

Also included in legend 500 are notations for digital certificates which are also referred to herein as “certificates” (e.g., certificates 114, 116, 118). A digital certificate may be used to establishing credentials when doing business or other transactions via a network such as the Internet. In a public key infrastructure, a digital certificate authenticates the identity of a sender of data and a public key of the sender. Digital certificates may be issued by a certificate authority which may also be referred to as a “registration authority” (e.g., certificate authority 112). A recipient of a digital certificate may confirm the identity of the sender (also known as a “subscriber” or “certificate owner”) with the certificate authority. In general, a digital certificate is a digital representation of information which may: identify the certification authority issuing the certificate; name or identify the subscriber associated with the certificate (such as, e.g., through inclusion of a serial number associated with the subscriber); contain a public key associated with the subscriber; identify an operational period of the certificate (e.g., a lifespan or expiration date of the certificate); and a digital signature of the issuing certification authority. The public key included in the certificate may be used to encrypt and decrypt messages and digital signatures. The digital signature included in the certificate may be used to verify the authenticity of the certificate. In embodiments of the present invention, certificates 114, 116, 118 may comprise X.509 digital certificates that conform to the X.509 International Telecommunications Union-T (“ITU-T”) standard.

Legend 500 further includes notations for personal data encryption keys 408 and session keys 512 (e.g., session keys 428, 436, 438, 462, 466). As set forth in the description column personal data encryption keys 408 and session keys 512 may comprise symmetric keys for use in symmetric cryptography in accordance with embodiments of the present invention. In symmetric cryptography, the same key (i.e., a “symmetric key”) is used for both encryption and decryption.

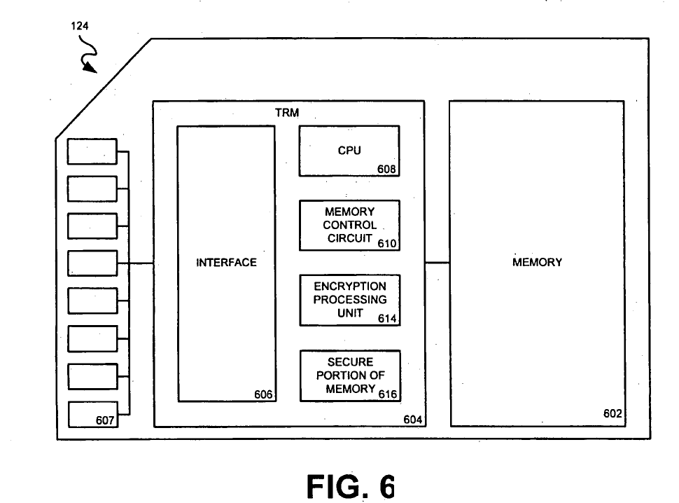

FIG. 6 is a schematic block diagram of an illustrative secure device 124 in accordance with an exemplary embodiment of the present invention. In this exemplary embodiment, the secure device 124 includes memory 602 comprising a flash memory or other similar type of non-volatile memory. Flash memory or flash Random Access Memory (RAM) may be defined as a type of non-volatile memory capable of retaining data after the power is removed. In general, flash memory comprises a solid-state, nonvolatile, rewritable memory that functions like a combination of RAM and hard disk. Flash memory is durable, operates at low voltages, and retains data when power is off. Flash memory cards may be used in digital cameras, cell phones, printers, handheld computers, pagers, and audio recorders. Typically, flash memory may be erased and rewritten under software control. An illustrative embodiment of the secure device 124 may comprise flash memory card products sold by Hitachi, Ltd under the name Secure MultiMediaCard (SMMC) or PIN-SMMC (personal identification number Secure MultiMediaCard).

With continuing reference to FIG. 6, the illustrative secure device 124 may include a tamper resistant module 604 containing selected components of the secure device 124. The tamper resistant module 604 may be adapted for disabling the components contained therein (and thereby disabling the secure device 124) if the tamper resistant module is tamper with. In one embodiment, the tamper resistant module 604 may also be adapted for withstanding cryptoanalysis. In the exemplary embodiment shown in FIG. 6, the tamper resistant module 604 may contain therein an interface 606 for interfacing the secure device 124 to a computer (e.g., terminal 106) via connectors 607 which couple the circuitry of the secure device 124 to the computer.

The tamper resistant module 604 may also contain a processor (or CPU) 608 capable of manipulating the memory 602 based on commands received by the interface 606 from a computer coupled to the secure device 124. Tamper resistant module 604 may further contain control circuitry 610 for controlling memory 602. The tamper resistant module 604 may also contain a secure portion 612 of the memory 602 for storing sensitive information such as private and public encryption keys (e.g., encryption keys 408, 404) associated with the secure device 124 and encrypted personal data stored in the memory 602 of the secure device 124. The tamper resistant module 604 may further include encryption processing circuitry 614 capable of performing encryption and other security processing based on encryption and security processing commands received from a computer coupled to the secure device 124.

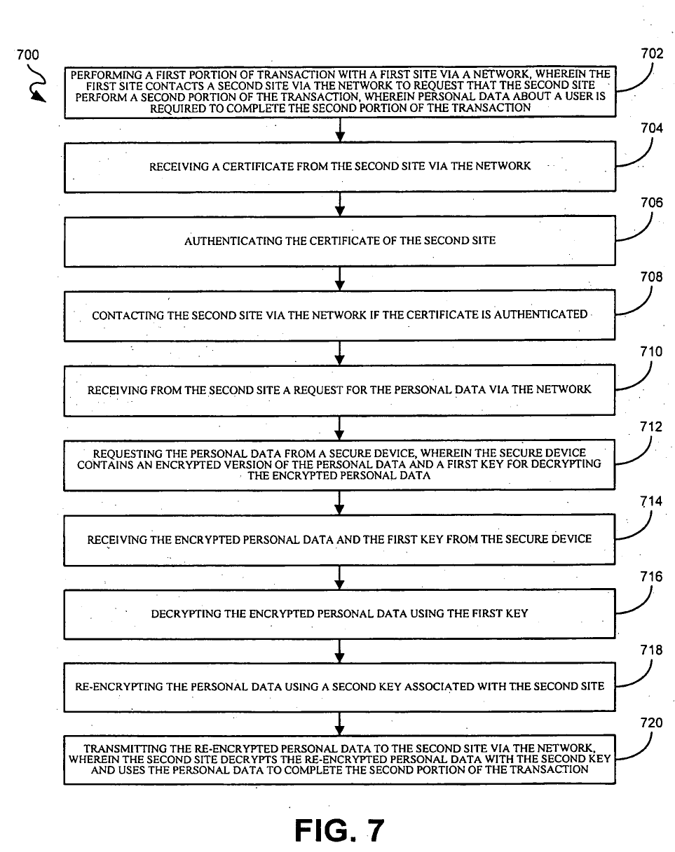

FIG. 7 is a flowchart of a process 700 for conducting a secure transaction via a network from the terminal's perspective in accordance with an embodiment of the present invention. A first portion of transaction is performed at or with a first site via a network in operation 702. The first site then contacts a second site via the network to request that the second site perform a second portion of the transaction in which personal data about a user is required. A certificate is received from the second site via the network and then authenticated in operations 704 and 706. If the certificate is authenticated, then the second site is contacted via the network in operation 708.

After contacting the second site, a request for the personal data is received from the second site via the network in operation 710. In operation 712, the requested personal data is requested from a secure device which contains an encrypted version of the personal data and a first key for decrypting the encrypted personal data. The encrypted personal data and the first key are received from the secure device in operation 714. Using the first key, the encrypted personal data is decrypted in operation 716.

The personal data is then re-encrypted using a second key associated with the second site in operation 718. In operation 720, the re-encrypted personal data is then transmitted to the second site via the network. The second site then decrypts the re-encrypted personal data with the second key and uses the personal data to complete the second portion of the transaction.

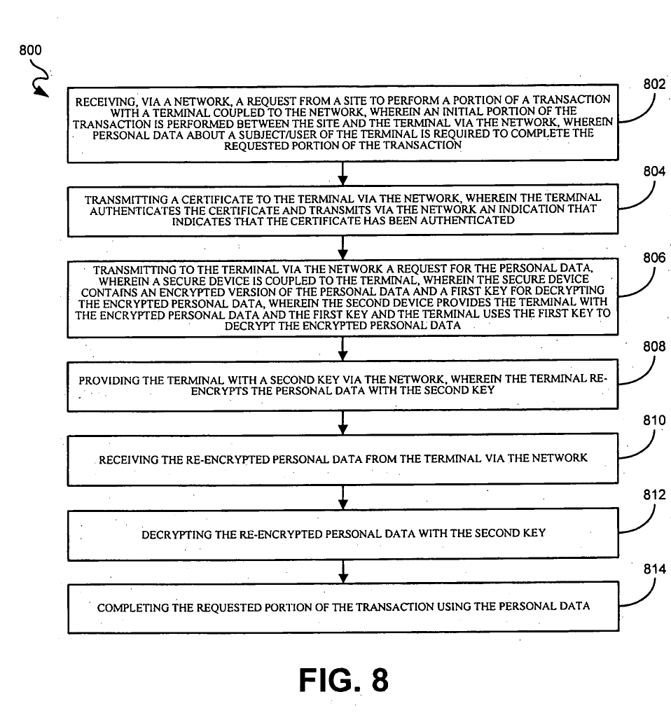

FIG. 8 is a flowchart of a process 800 for conducting a secure transaction via a network from the second site's 110 perspective in accordance with an embodiment of the present invention. A request to perform a portion of a transaction with a terminal coupled to the network is received via the network from a site (i.e., the first site) in operation 802. A first or initial portion of the transaction is or has been performed at the site and/or between the site and the terminal via the network. Personal data about a user of the terminal is required to complete the requested portion of the transaction.

A certificate is transmitted to the terminal via the network in operation 804. The terminal authenticates the certificate to verify the identity of the second site and then transmits via the network an indication that indicates that the certificate has been authenticated and that personal data may now be requested from the terminal. Upon receipt of the indication, a request for the personal data is transmitted to the terminal via the network in operation 806.

A secure device is coupled to the terminal. The secure device contains an encrypted version of the personal data and a first key for decrypting the encrypted personal data. The second device provides the terminal with the encrypted personal data and the first key and the terminal uses the first key to decrypt the encrypted personal data. The terminal is provided (or has been provided) with a second key via the network in operation 808. The terminal re-encrypts the personal data using the second key and then transmits the re-encrypted data via the network.

Upon receipt of the re-encrypted personal data from the terminal in operation 810, the re-encrypted personal data is decrypted with the second key in operation in operation 812 and the requested portion of the transaction is completed using the personal data in operation 814.

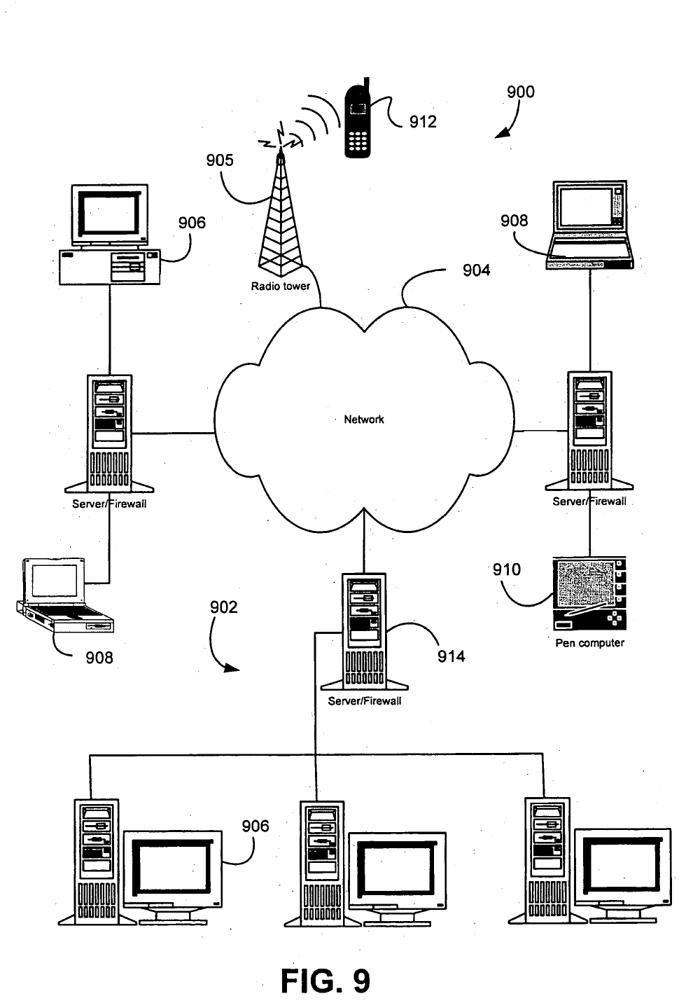

FIG. 9 illustrates an exemplary network system 900 with a plurality of components 902 in accordance with one embodiment of the present invention. As shown, such components include a network 904 which take any form including, but not limited to a local area network, a wide area network such as the Internet, and a wireless network 905. Coupled to the network 904 is a plurality of computers which may take the form of desktop computers 906, laptop or notebook computers 908 (including those with wireless networking capabilities), hand-held computers 910 (including wireless devices 912 such as wireless PDA's or mobile phones), or any other type of computing hardware/software. As an option, the various computers may be connected to the network 904 by way of a server 914 which may be equipped with a firewall for security purposes. It should be noted that any other type of hardware or software may be included in the system and be considered a component thereof.

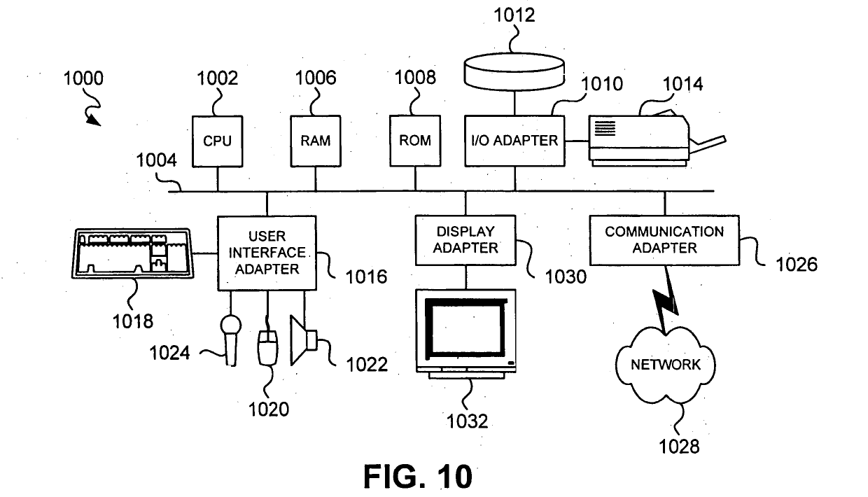

A representative hardware environment associated with the various components of FIG. 9 is depicted in FIG. 10. In the present description, the various sub-components of each of the components may also be considered components of the system. For example, particular software modules executed on any component of the system may also be considered components of the system. In particular, FIG. 10 illustrates an exemplary hardware configuration of a workstation 1000 having a central processing unit 1002, such as a microprocessor, and a number of other units interconnected via a system bus 1004.

The workstation shown in FIG. 10 includes a Random Access Memory (RAM) 1006, Read Only Memory (ROM) 1008, an I/O adapter 1010 for connecting peripheral devices such as, for example, disk storage units 1012, printers 1014, and the.secure device 124 to the bus 1004, a user interface adapter 1016 for connecting various user interface devices such as, for example, a keyboard 1018, a mouse 1020, a speaker 1022, a microphone 1024, and/or other interface devices such as a touch screen or a digital camera to the bus 1004, a communication adapter 1026 for connecting the workstation 1000 to a communication network 1028 (e.g., a data processing network) and a display adapter 1030 for connecting the bus 1004 to a display device 1032. The workstation may utilize an operating system such as, for example, the Microsoft Windows 95, NT, 98, 2000, ME, or XP Operating System (OS), the IBM OS/2 operating system, the MAC OS, Linux OS or UNIX operating system. Those skilled in the art will appreciate that the present invention may also be implemented on platforms and operating systems other than those mentioned. Embodiments of the present invention may also be implemented using computer program languages such as, for example, ActiveX , Java, C, and the C++ language and utilize object oriented programming methodology.

Transmission Control Protocol/Internet Protocol (TCP/IP) is a basic communication language or protocol of the Internet. It can also be used as a communications protocol in the private networks called intranet and in extranet. TCP/IP is a two-layering program. The higher layer, Transmission Control Protocol (TCP), manages the assembling of a message or file into smaller packet that are transmitted over the Internet and received by a TCP layer that reassembles the packets into the original message. The lower layer, Internet Protocol (IP), handles the address part of each packet so that it gets to the right destination. Each gateway computer on the network checks this address to see where to forward the message. Even though some packets from the same message are routed differently than others, they'll be reassembled at the destination.

TCP/IP uses a client/server model of communication in which a computer user (a client) requests and is provided a service (such as sending a Web page) by another computer (a server) in the network. TCP/IP communication is primarily point-to-point, meaning each communication is from one point (or host computer) in the network to another point or host computer. TCP/IP and the higher-level applications that use it are collectively said to be “stateless” because each client request is considered a new request unrelated to any previous one (unlike ordinary phone conversations that require a dedicated connection for the call duration). Being stateless frees network paths so that everyone can use them continuously. (Note that the TCP layer itself is not stateless as far as any one message is concerned. Its connection remains in place until all packets in a message have been received.).

Protocols related to TCP/IP include the User Datagram Protocol (UDP), which is used instead of TCP for special purposes. Other protocols are used by network host computers for exchanging router information. These include the Internet Control Message Protocol (ICMP), the Interior Gateway Protocol (IGP), the Exterior Gateway Protocol (EGP), and the Border Gateway Protocol (BGP).

Internetwork Packet Exchange (IPX) is a networking protocol from Novell that interconnects networks that use Novell's NetWare clients and servers. IPX is a datagram or packet protocol. IPX works at the network layer of communication protocols and is connectionless (that is, it doesn't require that a connection be maintained during an exchange of packets as, for example, a regular voice phone call does).

Packet acknowledgment is managed by another Novell protocol, the Sequenced Packet Exchange (SPX). Other related Novell NetWare protocols are: the Routing Information Protocol (RIP), the Service Advertising Protocol (SAP), and the NetWare Link Services Protocol (NLSP).

A virtual private network (VPN) is a private data network that makes use of the public telecommunication infrastructure, maintaining privacy through the use of a tunneling protocol and security procedures. A virtual private network can be contrasted with a system of owned or leased lines that can only be used by one company. The idea of the VPN is to give the company the same capabilities at much lower cost by using the shared public infrastructure rather than a private one. Phone companies have provided secure shared resources for voice messages. A virtual private network makes it possible to have the same secure sharing of public resources for data.

Using a virtual private network involves encryption data before sending it through the public network and decrypting it at the receiving end. An additional level of security involves encrypting not only the data but also the originating and receiving network addresses. Microsoft, 3Com, and several other companies have developed the Point-to-Point Tunneling Protocol (PPP) and Microsoft has extended Windows NT to support it. VPN software is typically installed as part of a company's firewall server.

Wireless refers to a communications, monitoring, or control system in which electromagnetic radiation spectrum or acoustic waves carry a signal through atmospheric space rather than along a wire. In most wireless systems, radio frequency (RF) or infrared transmission (IR) waves are used. Some monitoring devices, such as intrusion alarms, employ acoustic waves at frequencies above the range of human hearing. Common examples of wireless equipment in use today include the Global Positioning System, cellular telephone phones and pagers, cordless computer accessories (for example, the cordless mouse), home-entertainment-system control boxes, remote garage-door openers, two-way radios, and baby monitors. An increasing number of companies and organizations are using wireless LAN. Wireless transceivers are available for connection to portable and notebook computers, allowing Internet access in selected cities without the need to locate a telephone jack. Eventually, it will be possible to link any computer to the Internet via satellite, no matter where in the world the computer might be located.

Bluetooth is a computing and telecommunications industry specification that describes how mobile phones, computers, and personal digital assistants (PDA's) can easily interconnect with each other and with home and business phones and computers using a short-range wireless connection. Each device is equipped with a microchip transceiver that transmits and receives in a previously unused frequency band of 2.45 GHz that is available globally (with some variation of bandwidth in different countries). In addition to data, up to three voice channels are available. Each device has a unique 48-bit address from the IEEE 802 standard. Connections can be point-to-point or multipoint. The maximum range is 10 meters. Data can presently be exchanged at a rate of 1 megabit per second (up to 2 Mbps in the second generation of the technology). A frequency hop scheme allows devices to communicate even in areas with a great deal of electromagnetic interference. Built-in encryption and verification is provided.

Encryption is the conversion of data into a form, called a ciphertext, that cannot be easily understood by unauthorized people. Decryption is the process of converting encrypted data back into its original form, so it can be understood.

Rivest-Shamir-Adleman (RSA) is an Internet encryption and authentication system that uses an algorithm developed in 1977 by Ron Rivest, Adi Shamir, and Leonard Adleman. The RSA algorithm is a commonly used encryption and authentication algorithm and is included as part of the Web browser from Netscape and Microsoft. It's also part of Lotus Notes, Intuit's Quicken, and many other products. The encryption system is owned by RSA Security.

The RSA algorithm involves multiplying two large prime numbers (a prime number is a number divisible only by that number and 1) and through additional operations deriving a set of two numbers that constitutes the public key and another set that is the private key. Once the keys have been developed, the original prime numbers are no longer important and can be discarded. Both the public and the private keys are needed for encryption /decryption but only the owner of a private key ever needs to know it. Using the RSA system, the private key never needs to be sent across the Internet.

The private key may be used to decrypt text that has been encrypted with the public key. For example, to send a message to a recipient, a sender first obtains the recipient's public key (but not the recipient's private key) from a central administrator and encrypt the message using the recipient's public key. When the recipient receives the encrypted message from the sender, the recipient may then decrypt the encrypted message with the recipient's private key. In addition to encrypting messages (which ensures privacy), senders may also authenticate themselves to recipients (so that the recipient can verify the identity of the sender) by using the sender's own private key to encrypt a digital certificate. When the recipient receives the digital certificate, the recipient can use the sender's public key to decrypt it.

The Secure Sockets Layer (SSL) is a commonly-used protocol for managing the security of a message transmission on the Internet. SSL has recently been succeeded by Transport Layer Security (TLS), which is based on SSL. SSL uses a program layer located between the Internet's Hypertext Transfer Protocol (HTTP) and Transport Control Protocol (TCP) layers. SSL uses the public-and-private key encryption system from RSA, which also includes the use of a digital certificate. A SSL protocol is described in the SSL Protocol Version 3.0 by the Transport Layer Security Working Group, Nov. 18, 1996 for providing communications privacy over the Internet and allowing client/server applications to communicate in a way that is designed to prevent eavesdropping, tampering, or message forgery, the disclosure of which is incorporated herein by reference in its entirety.

Transport Layer Security (TLS) is a protocol that ensures privacy between communicating applications and their users on the Internet. When a server and client communicate, TLS ensures that no third party may eavesdrop or tamper with any message. TLS is a successor to the Secure Sockets Layer (SSL). TLS is composed of two layers: the TLS Record Protocol and the TLS Handshake Protocol. The TLS Record Protocol provides connection security with some encryption method such as the Data Encryption Standard (DES). The TLS Record Protocol can also be used without encryption. The TLS Handshake Protocol allows the server and client to authenticate each other and to negotiate an encryption algorithm and cryptographic keys before data is exchanged. The TLS protocol is based on Netscape's SSL 3.0 protocol; however, TLS and SSL are not interoperable. The TLS protocol does contain a mechanism that allows TLS implementation to back down to SSL 3.0. A TLS protocol is described in the document entitled, “The TLS Protocol, Version 1” by the Network Working Group of the Internet Society, 1999, the disclosure of which is incorporated herein by reference in its entirety. This document specifies Version 1.0 of the Transport Layer Security (TLS) protocol. The TLS protocol provides communications privacy over the Internet. The protocol allows client/server applications to communicate in a way that is designed to prevent eavesdropping, tampering, or message forgery.

Wireless Transport Layer Security (WTLS) is the security level for Wireless Application Protocol (WAP) applications. Based on Transport Layer Security (TLS) v1.0 (a security layer used in the Internet, equivalent to Secure Socket Layer 3.1), WTLS was developed to address the problematic issues surrounding mobile network devices—such as limited processing power and memory capacity, and low bandwidth—and to provide adequate authentication, data integrity, and privacy protection mechanisms.

The Wired Equivalent Privacy (WEP) algorithm, is part of the 802.11 standard. The 802.11 standard describes the communication that occurs in wireless local area networks (LANs). The Wired Equivalent Privacy (WEP) algorithm is used to protect wireless communication from eavesdropping. A secondary function of WEP is to prevent unauthorized access to a wireless network; this function is not an explicit goal in the 802.11 standard, but it is frequently considered to be a feature of WEP. WEP relies on a secret key that is shared between a mobile station (e.g. a laptop with a wireless Ethernet card) and an access point (i.e. a base station). The secret key is used to encrypt packets before they are transmitted, and an integrity check is used to ensure that packets are not modified in transit. The standard does not discuss how the shared key is established. In practice, most installations use a single key that is shared between all mobile stations and access points.

Based on the foregoing specification, the invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware to create a computer system or computer sub-system embodying the method of the invention.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

1. A system for conducting a transaction via a network, comprising:
a first site coupled to a network;
a terminal coupled to the network for performing a first portion of a transaction with the first site via the network;
a second site coupled to the network for performing a second portion of the transaction that requires personal data, wherein the second site transmits to the terminal via the network a certificate for verifying the identity of the second site;
a secure device coupled to the terminal, the secure device containing an encrypted version of the personal data and a first key for decrypting the encrypted personal data, wherein the secure device provides the terminal with the encrypted personal data and the first key to the terminal;
the terminal having logic for decrypting the encrypted personal data using the first key, logic for re-encrypting the decrypted personal data with a second key, and logic for transmitting the re-encrypted personal data to the second site via the network; and
the second site having logic for decrypting the re-encrypted personal data and logic for using the personal data to complete the second portion of the transaction.

2. The system of claim 1, wherein the secure device includes a special region that, if tampered with, renders the secure device inoperable and thereby prevent access to the first key contained therein.

3. The system of claim 1, wherein communications between the terminal and the secure device and between the terminal and the second site are encrypted with one or more symmetric keys.

4. The system of claim 1, wherein the personal data includes at least one of credit card information and credit history information.

5. The system of claim 1, wherein a list containing information for authenticating the certificate of the second site is transmitted from the first site to the terminal via the network prior to receipt of the certificate by the terminal.

6. The system of claim 1, wherein the transaction comprises a commercial transaction and the first site comprises an e-commerce site.

7. The system of claim 1, wherein the secure device provides the terminal with the encrypted personal data prior to and separately from the first key.

8. The system of claim 1, wherein the second key comprises a public key associated with the second site.

9. The system of claim 1, wherein a second certificate associated with the terminal is provided to the secure device to authenticate the terminal before the secure device provides the terminal with the encrypted personal data and first key.

10. The system of claim 1, wherein a notification is transmitted from the second site to the first site via the network upon completion of the second portion of the transaction.

11. The system of claim 1, wherein the secure device is detachably coupled to the terminal.

12. A method for conducting a transaction via a network, comprising the steps of:
receiving, via a network, a request from a site to perform a portion of a transaction with a terminal coupled to the network, wherein an initial portion of the transaction is performed between the site and the terminal via the network, wherein personal data about a user of the terminal is required to complete the requested portion of the transaction;
transmitting a certificate to the terminal via the network, wherein the terminal authenticates the certificate and transmits via the network an indication that indicates that the certificate has been authenticated;
transmitting a request for the personal data to the terminal via the network, wherein a secure device is coupled to the terminal, wherein the secure device contains an encrypted version of the personal data and a first key for decrypting the encrypted personal data, wherein the second device provides the terminal with the encrypted personal data and the first key and the terminal uses the first key to decrypt the encrypted personal data;
providing the terminal with a second key via the network, wherein the terminal re-encrypts the personal data with the second key;
receiving the re-encrypted personal data from the terminal via the network;
decrypting the re-encrypted personal data with the second key; and
completing the requested portion of the transaction using the personal data.

13. The method of claim 12, wherein the secure device includes a special region that, if tampered with, renders the secure device inoperable and thereby prevent access to the first key contained therein.

14. The method of claim 12, wherein communications with the secure device and the terminal are encrypted with one or more symmetric keys.

15. The method of claim 12, wherein the personal data includes at least one of credit card information and credit history information.

16. The method of claim 12, wherein, prior to transmission of the certificate to the terminal, the site transmits to the terminal via the network a list containing information for authenticating the certificate.

17. The method of claim 12, wherein the secure device provides the terminal with the encrypted personal data prior to and separately from the first key.

18. The method of claim 12, wherein a second certificate associated with the terminal is provided to the secure device to authenticate the terminal before the secure device provides the terminal with the encrypted personal data and first key.

19. The method of claim 12, further comprising notifying the site via the network of the completion of the requested portion of the transaction.

20. A computer program product for conducting a transaction via a network, comprising the steps of:
computer code for performing a first portion of transaction with a first site via a network, wherein the first site contacts a second site via the network to request that the second site perform a second portion of the transaction, wherein personal data about a user is required to complete the second portion of the transaction;
computer code for receiving a certificate from the second site via the network;
computer code for authenticating the certificate of the second site;
computer code for contacting the second site via the network if the certificate is authenticated;
computer code for receiving a request for the personal data from the second site via the network;
computer code for requesting the personal data from a secure device, wherein the secure device contains an encrypted version of the personal data and a first key for decrypting the encrypted personal data;
computer code for receiving the encrypted personal data and the first key from the secure device;
computer code for decrypting the encrypted personal data using the first key;
computer code for re-encrypting the personal data using a second key associated with the second site; and
computer code for transmitting the re-encrypted personal data to the second site via the network, wherein the second site decrypts the re-encrypted personal data with the second key and uses the personal data to complete the second portion of the transaction.
